(19) United States
(12) Patent Application Publication
(10) Pub. No.: US 2009/0041322 A1
(43) Pub. Date: Feb. 12, 2009

(54) Computer Assisted Detection of Polyps Within Lumen Using Enhancement of Concave Area

(75) Inventor: Matthias Wolf, Coatesville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Seimens Medical Solutions USA, Inc., Malvern, PA (US)

(21) Appl. No.: 12/169,772

(22) Filed: Jul. 9, 2008

Related U.S. Application Data
(60) Provisional application No. 60/948,766, filed on Jul. 10, 2007.

(51) Int. Cl. G06K 9/00

(52) U.S. Cl. 382/131

(57) ABSTRACT

A method for performing computer assisted diagnosis, includes receiving medical image data of a structure under analysis including background and foreground pixels, matching a set of one or more masks to foreground pixels of the acquired medical image data, converting a background pixel of the acquired medical image data to foreground pixel based on a match between one of the masks and the acquired medical image data, performing morphological dilation on the medical image data with the converted pixel, performing morphological erosion on the dilated medical image data, and identifying one or more regions of interest based on a difference between the original acquired medical image data and the eroded medical image data.

### CROSS-REFERENCE TO RELATED APPLICATION

The present application is based on provisional application Ser. No. 60/948,766, filed Jul. 10, 2007, the entire contents of which are herein incorporated by reference.

### BACKGROUND OF THE INVENTION

1. Technical Field

The present disclosure relates to the detection of polyps and, more specifically, to the computer assisted detection of polyps within a lumen using enhancement of a concave area.

2. Discussion of Related Art

Computer-assisted diagnosis (CAD) is the process of using computers to analyze medical images and automatically detects structural features that may be indicative of disease. CAD may thus combine radiographic imaging techniques and artificial intelligence to detect and classify disease in a non-invasive way.

CAD may begin with the acquisition of medical image data using one or more imaging modality. For example, images may be acquired using two-dimensional modalities such as conventional x-rays or images may be acquired using three-dimensional modalities such as computed tomography (CT) or magnetic resonance imaging (MRI). The image data may then be analyzed using one or more CAD techniques to identify regions of suspicion. Regions of suspicion may represent internal structures that have an elevated likelihood of being subject to disease.

A medical practitioner, for example, a radiologist, may then review the medical image data and the identified regions of interest to determine whether disease is present and to devise a course of treatment. Accordingly, the medical practitioner may use CAD to identify portions of the medical image that may deserve special attention.

Effective CAD may therefore lead to more efficient and accurate diagnosis of disease and may thus contribute to less costly and more accurate medical care.

One field in which CAD has been applied is virtual colonoscopy (VC). In VC, three-dimensional image data of a patient's colon is analyzed to diagnose colon and bowel disease, including polyps, diverticulosis and cancer. In conventional VC, the three-dimensional image data is rendered to produce an image of the colon from the point of view of an imaginary camera located within the lumen of the colon. The medical practitioner may then examine a virtual fly-through whereby sequential images are presented as if the imaginary camera is moved through the colon lumen. If, for example, the medical practitioner identified what might be a polyp, a conventional colonoscopy may be performed to further examine the potential polyp and, if necessary, remove it.

As applied to virtual colonoscopy, CAD may be used to highlight regions of suspicion within the rendered fly-through images. Alternatively, CAD may be used to highlight regions of suspicion in a two-dimensional image slice of the medical image data. In either case, CAD techniques may be employed to direct the medical practitioner's attention to any discovered regions of suspicion so that a diagnosis may be rendered.

Another field in which CAD has been applied to is the detection of disease within the lungs. Here, three-dimensional image data of a patient's lungs is analyzed to diagnose lung disease including pleura-attached nodules. As described above, CAD techniques may be employed to direct the medical practitioner's attention to any discovered regions of suspicion within the lungs so that a diagnosis may be rendered.

The accurate computer-assisted identification of colonic polyps, in the case of VC, and wall-attached nodules, in the case of lung imaging, can be difficult where the suspicious structures appear to penetrate into the lumen or lung, leaving a concave area in the contour/surface of the structure of the imaged organ. This identification may be especially difficult where the concavity is subtle, as is the case where the polyp or nodule is particularly flat in shape.

### SUMMARY

A method for performing computer assisted diagnosis, includes acquiring medical image data, matching a set of one or more masks to the acquired medical image data, converting a background pixel of the acquired medical image data to foreground pixel based on a match between one of the masks and the acquired medical image data, performing morphological dilation on the medical image data with the converted pixel, performing morphological erosion on the dilated medical image data, and identifying one or more regions of interest based on a difference between the original acquired medical image data and the eroded medical image data.

The medical image data may be CT image data, MR image data, ultrasound image data, or PET image data. The set of one or more masks may include a master mask and one or more other masks that include a geometric pattern of the master mask that has been flipped or rotated. The geometric pattern of the master mask may be selected to match the region of interest based on domain knowledge pertaining to the region of interest. The set of one or more masks may include an L-shaped pattern.

The steps of matching the masks, converting the background pixel, performing the morphological dilation, and performing morphological erosion may fill in one or more gaps within the acquired medical image.

The steps of matching the masks, converting the background pixel, and performing the morphological dilation may be repeated for a number of times “n” that is dependent upon the size of the one or more gaps that are filled. The step of performing morphological erosion on the dilated medical image data may be repeated for a number of times “m” wherein m≧n.

The medical image data may include an image of a colon and the one or more regions of interest represent colonic polyp candidates or the medical image data may include an image of a lung and the one or more regions of interest represent pleura-attached nodule candidates, or a stenosis in a blood vessel or other tubular structure.

For colonic polyps, the lesions may be shallow and protruding slightly into the lumen of the colon, or by trivially inverting the foreground and background masks, slightly depressed lesions may also be detected.

A method for performing computer assisted diagnosis includes acquiring medical image data, converting a background pixel of the acquired medical image data to foreground pixel based on domain knowledge pertaining to an abnormality, such that initially, voxels within the lumen of the colon are labeled as foreground pixels, and the tissue of the colon wall, folds and surrounding structures are background tissue. Morphological dilation is performed on the medical image data with the converted pixel, performing morphological erosion on the dilated medical image data, and identifying one or more abnormality candidates based on a difference between the original acquired medical image data foreground pixels and the eroded medical image data foreground pixels.

The medical image data may be CT image data, MR image data, ultrasound image data, or PET image data.

A set of one or more masks may be used to convert the background pixel of the acquired medical image data to the foreground pixel by matching the masks to the acquired medical image data. The set of one or more masks may include a master mask and one or more other masks that include a geometric pattern of the master mask that has been flipped or rotated. The set of one or more masks may include an L-shaped pattern.

The steps of converting the background pixel and performing the morphological dilation may be repeated for a number of times “n” and the step of performing morphological erosion on the dilated medical image data is repeated for a number of times “m” wherein m≧n.

The medical image data may include an image of a colon and the one or more regions of interest represent colonic polyp candidates or the medical image data may include an image of a lung and the one or more regions of interest represent pleura-attached nodule candidates.

A computer system includes a processor and a program storage device readable by the computer system, embodying a program of instructions executable by the processor to perform method steps for performing computer assisted diagnosis. The method includes acquiring medical image data, matching a set of one or more masks to the acquired medical image data, converting a background pixel of the acquired medical image data to foreground pixel based on a match between one of the masks and the acquired medical image data, performing morphological dilation on the medical image data with the converted pixel, performing morphological erosion on the dilated medical image data, and identifying one or more regions of interest based on a difference between the original acquired medical image data and the eroded medical image data.

The steps of matching the masks, converting the background pixel, and performing the morphological dilation are repeated for a number of times “n” and the step of performing morphological erosion on the dilated medical image data is repeated for a number of times “m” wherein m≧n.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flowchart illustrating an approach for closing concavity in a medical image according to an exemplary embodiment of the present invention;

FIG. 2 is an illustration showing a set of L-shaped masks that may be used according to exemplary embodiments of the present invention;

FIG. 3 is an illustration showing morphological closing according to an exemplary embodiment of the present invention;

FIG. 4 is an illustration showing computer-assisted diagnosis (CAD) according to an exemplary embodiment of the present invention; and

FIG. 5 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide a fast and sensitive approach for computer-assisted identification of lumen or lung concavity that may be indicative of disease. Such an approach may be used, for example, to identify regions of interest so that a medical practitioner can use the identified regions of interest to assist in determining whether disease, such as colonic polyps and pleura-attached nodules, are present in the imaged organs.

Exemplary embodiments of the present invention may be applied to medical image data that has been acquired from any medical imaging device. For example, exemplary embodiments of the present invention may use medical image data that is a result of computed-tomography (CT), magnetic resonance (MR), ultrasound, positron emission tomography (PET), as well as medical image data from other sources.

According to exemplary embodiments of the present invention, identification of regions of interest may include the location of concavity. This is because the structure of colonic polyps and pleura-attached nodules tend to protrude into the lumen or the lung, leaving a concave imprint in the surface contour of the segmented colon or lung, respectively. Accordingly, identification of concavity may be a first step in performing computer-assisted identification.

Where concavity is highly pronounced with respect to the surface contour of the organ being examined, identification of concavity may be more easily performed. However, where concavity is subtle, for example, where the lesion or nodule is substantially flat, it may be difficult or impossible for existing techniques to identify concavity quickly and accurately.

In processing medical images, a technique known as morphological closing may be employed. In morphological closing, noise, in the form of small gaps in the image data, may be removed by performing dilation of the medical image data followed by erosion. Accordingly, two operations are performed on the image data. First, dilation is applied. In dilation, objects within the foreground of the image data are enlarged. Then, in erosion, the foreground objects are shrunk, essentially to their initial size. In the process of enlarging the foreground images, small concavities may be filled. Then, when erosion is performed, the image is restored to its original size but the concavities are no longer present.

Accordingly, the effect of this process is to fill the small gaps in the image data. As these gaps may constitute an interruption or concavity in the contour.

After the image has been restored to its original size, the final image may be compared to the initial image to determine the location of any concavities that have been filled during the morphological closing operation.

Existing techniques for performing morphological closings may have trouble with filling concavities in the contour/surface of the region or volume. This trouble may be the result of imaging noise and other minute image artifacts that may be difficult to distinguish from actual concavities.

In traditional morphological closing, no domain knowledge is used to aid in differentiating between actual concavities and image noise and/or artifacts. Accordingly, traditional morphological closing may actually remove detail that differentiates between actual concavities and image noise and/or artifacts rather than further differentiating them.

Exemplary embodiments of the present invention provide a novel approach to morphological closing that makes use of domain knowledge. For example, it may be understood that concavities that are indicative of disease may have an “L” shaped corner within the concavity. In this approach a set of masks are used to identify and fill concave areas in the contour/surface of the region or volume. For example, the masks may be designed to match an “L” shaped corner within the image foreground.

These masks may be two-dimensional. Two-dimensional masks may be used to match with regions of two-dimensional image data or a two-dimensional slice of three-dimensional image data. Alternatively, the masks may be three-dimensional so that filling of concavity may be performed directly on three-dimensional image data.

As explained herein, the set of masks may be described in terms of two-dimensions for the purposes of simplified explanation, however, it is to be understood that the features of these masks may be extended into a set of three-dimensional masks.

The complete set of masks may be produced from one or more master masks. For example, the master masks may be rotated and/or flipped to produce the complete set of masks. Accordingly, where the master mask illustrates an “L” shape of, the image foreground, the complete set of masks may include the same geometric pattern rotated 90°, 180°, and 270°, and flipped about the y-axis and the z-axis. Other rotations and/or flips may also be used to produce additional masks.

Where the mask is a three-dimensional mask, rotations and flips may be performed about the x-axis, the y-axis and the z-axis.

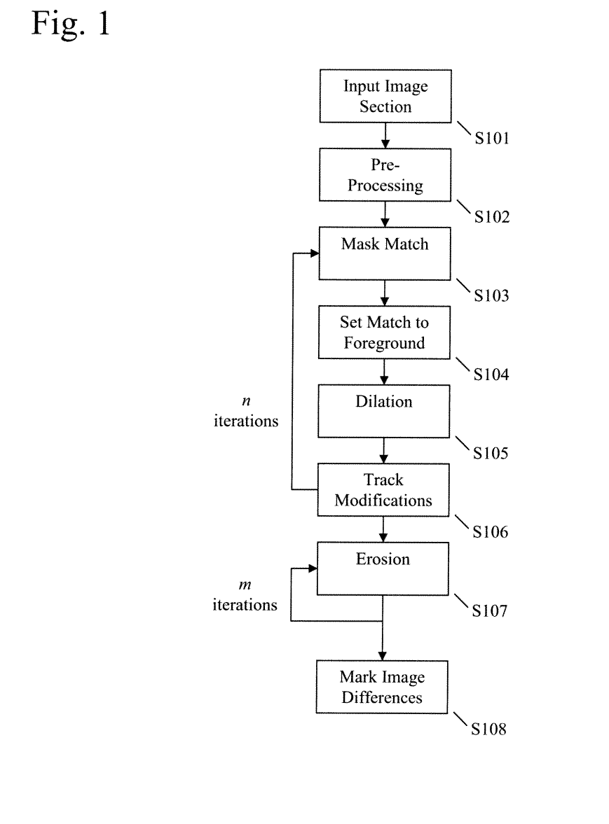

FIG. 1 is a flowchart illustrating an approach for closing concavity in a medical image according to an exemplary embodiment of the present invention. A medical image may be acquired and processed. The acquired medical image may be either two-dimensional or three-dimensional. In processing the medical image, each pixel may be set as either foreground or background according to predetermined criteria. The criteria may be, for example, an intensity threshold wherein pixels with intensities above the threshold are foreground and pixels with intensities below the threshold are background.

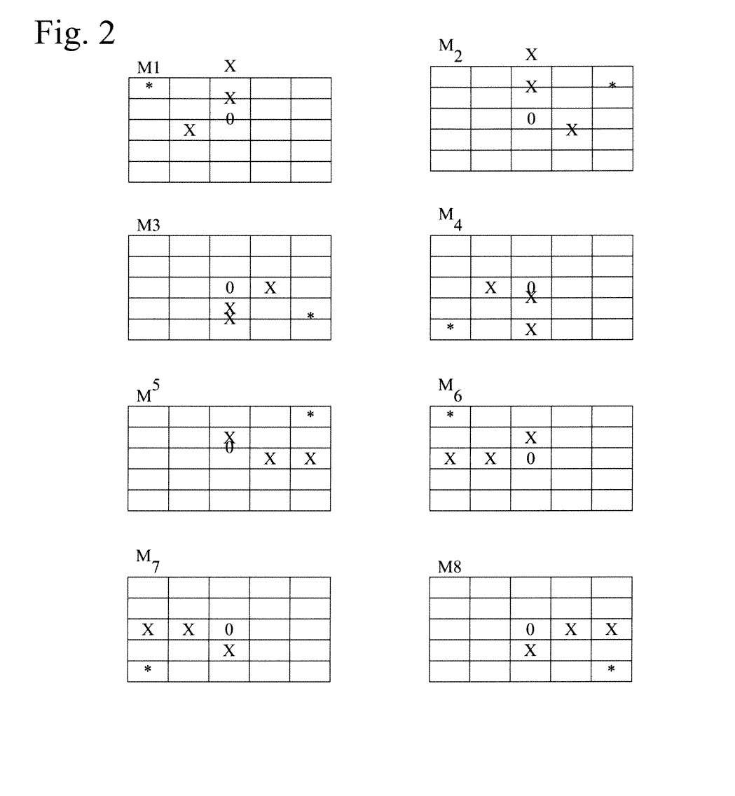

First, an image with one continuous foreground region may be taken as input (Step S101). Where the complete image data includes multiple foreground regions, a subsection of the image data including only one continuous foreground region may be used (Step S102). Then all background pixels that should be set to foreground are identified and collected. The image may then be searched for the desired shape using the set of masks (Step S103). For example, an L-shape may be the desired shape that is searched for at this step. FIG. 2 is an illustration showing a set of L-shaped masks that may be used according to exemplary embodiments of the present invention. Because L-shaped corners may be indicatives of concave areas relating to colonic polyps and pleura-attached nodules, L-shaped masks may be desirable.

However, the invention is not limited to the use of L-shaped masks, and masks may be based on other geometric shapes and patterns.

In FIG. 2, 8 masks M1 through M8 are shown. In these masks, “0” denotes the position of the current pixel, and is, as such, at the center of each mask. Foreground pixels are denoted with an “X”. Background pixels are denoted with an “*”. Unmarked pixels are not considered and may either be foreground or background. Thus mask M1 is a backwards L-shape. Here, mask M1 may be considered the master mask, and each subsequent mask may be a flip and/or rotation thereof. Mask M2 is a flip of M1 about the y-axis. Mask M3 is a 180° clockwise rotation of M1. Mask M4 is a combination of a y-axis flip and a 180° clockwise rotation of M1. Mask M5 is a 270° clockwise rotation of M1. Mask M6 is a combination of a y-axis flip and a 270° clockwise rotation of M1. Mask M7 is a 90° clockwise rotation of M1. Mask M8 is a combination of a y-axis flip and a 90° clockwise rotation of M1. These masks may form the complete set of masks or other combinations of rotations and flips may be used. Rotations are not limited to right angles, in fact masks may be formed from rotations of any number of degrees or fractional degrees from the master mask.

Where three-dimensional masks are used, flips may also be performed about the x-y plane and rotations may be performed about any of the x, y, and/or z-axes. For the purposes of simplifying the explanation, three-dimensional masks are not shown.

Accordingly, the neighborhood of each pixel is compared against each mask to find matches. For each region of the image data that is successfully matched to one or more masks, a particular single pixel in the neighborhood of the match is set to foreground (Step S104) in accordance with the mask so that during subsequent morphological dilation (Step S105), the vicinity of the match may receive more enhancement than other areas of the image data where no match was detected. Accordingly, actual concavity that may be indicative of disease may be increasingly differentiated from image noise and/or artifacts.

In applying each mask, for example, the masks M1 through M8 illustrated in FIG. 2 to each foreground pixel, concave areas may be detected. Each of the masks are matched to the image data when all of the “X” regions of the masks correspond to foreground pixels of the image and the “*” region of the mask correspond to a background pixel of the image. In step S104 described above, the background pixel corresponding the “*” region of the mask is marked and set to the foreground. Then, during the dilation step S105 described above, all pixels within a neighborhood (for example, a 3×3 pixel area) are set as foreground to enlarge the foreground image.

These steps of applying the set of masks (Step S103), setting the matched background pixel to foreground (Step S104), and performing dilation (Step S105) may be repeated “n” times. The greater the number n, the larger the dilation becomes. The number of iterations “n” may depend upon the size of the gaps that have to be filled. Larger gaps may require larger dilation and thus more iterations whereas smaller gaps may require smaller dilation and thus fewer iterations. During these repeated dilation steps, the area of the object is continuously enlarged and gaps are continuously filled. All modifications may be tracked (Step S106).

After this process has been repeated “n” times, erosion may be performed (Step S107). Erosion (Step S107) may be repeated “m” times, where the number of iterations “m” depends on the extent of erosion desired to return the object to substantially its original size. In general, m≧n. As a result of erosion, most of the object is returned to its original size, however, features of the concavities may remain enlarged and thereby more pronounced with respect to the surrounding structure.

The process of dilation and erosion with mask detection, as discussed above, represents a novel modified morphological closing approach that incorporates domain knowledge and is able to affectively identify concavity that might be indicative of disease such as colonic polyps and pleura-attached nodules.

The number of dilation iterations “n” may be encoded into the foreground information. Accordingly, the thickness of the original concavity may be inferred from this number of iterations. This information may then be used to refine the results of the image processing to remove thin strips or lines, such as lines that are one pixel thick and/or other regions that do not meet a predetermined thickness threshold by determining connected regions and the last iteration number in which a pixel was added for all the pixels belonging to such a region.

After modified morphological closing any subsequent refinements have been performed, a difference image may be calculated to isolate how the image has changed as a result of the prior steps (Step S108). This difference image may be a subtraction of the closed image from the initial image. The difference image may then be highlighted and displayed along with the original image. This may result in a highlighting of those gaps that were filled as a result dilation and erosion.

This highlighted image data may then be analyzed by the medical practitioner to render a diagnosis, for example, concerning the presence of colonic polyps and pleura-attached nodules. However, the techniques described in this disclosure may be applied to other forms of CAD and need not be limited to the detection of colonic polyps and pleura-attached nodules.

Exemplary embodiments of the present invention may also incorporate additional domain knowledge into the approach discussed above. For example, pixels may be removed from the foreground if their intensity value falls within a predetermined range. Other additional domain knowledge about colonic polyps and pleura-attached nodules may be similarly applied to further ensure that concavities indicative of these regions are exaggerated as a result of the modified morphological closing discussed herein.

After regions of concavity have been identified, the identified regions may be marked as regions of interest. Marked regions may then be presented to a medical practitioner, for example, by highlighting the concavities on the original image data. The medical practitioner may then review the medical images with particular emphasis placed on the detected regions of interest. Diagnosis may thus be rendered form the medical image data with the aid of the detected regions of interest.

Moreover, after the region of suspicion has been detected, it is not necessary that diagnosis be performed by a medical practitioner. For example, diagnosis may be automatically performed by a computer system.

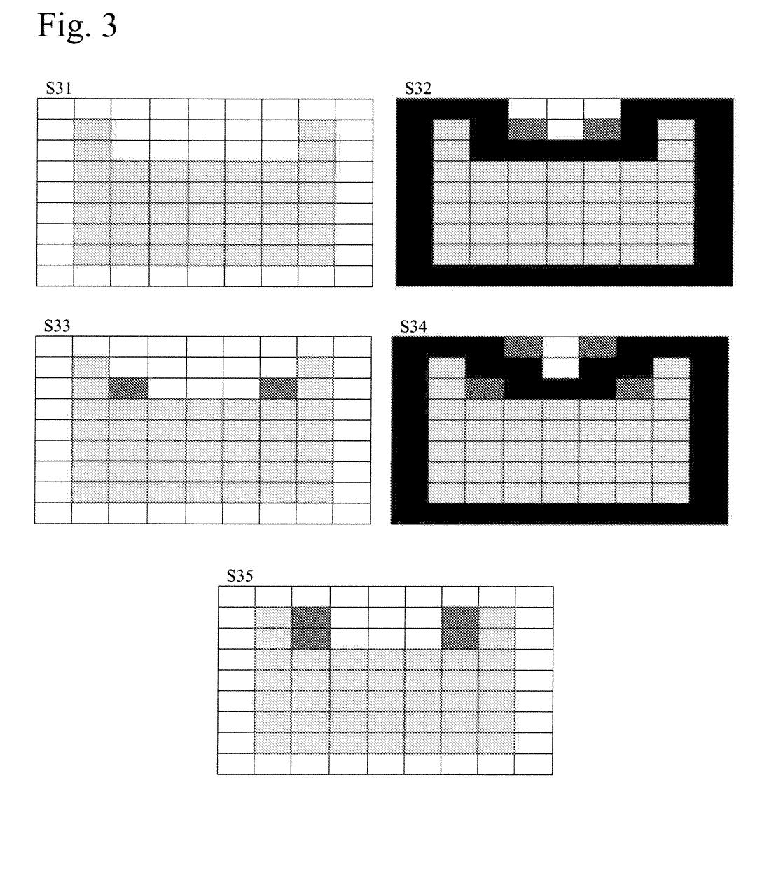

FIG. 3 is an illustration showing morphological closing according to an exemplary embodiment of the present invention. In a first step, image data is represented in the image S31. Here, the gray pixels represent the initial image data wherein a gap five pixels wide and two pixels tall may be seen at the top of the image matrix. This gap may be symbolic of a polyp. In the next step, as seen in image S32, the masks are applied to the image data and the hatch-shaded pixels represent pixels that are changed from background pixels to foreground pixels in accordance with the mask matches. The black pixels represent the dilation that is performed. In the next step, as seen in image S33, erosion is performed and thus the image is returned to substantially its original size, however, the hatch-shaded pixels remain incorporated into the eroded image. In the next step, as seen in image S34, matching and dilation steps are repeated. In the next step, as seen in image S35, erosion is repeated. It can be clearly seen that from the above-described iterations of matching, dilation, and erosion, the resultant image has filled in pixels that were part of the gap of the original image. When further iterations are performed, the ultimate result will be to completely fill the gap of the colonic polyp. At that point, a comparison of the initial and final images may result in the complete segmentation of the colonic polyp.

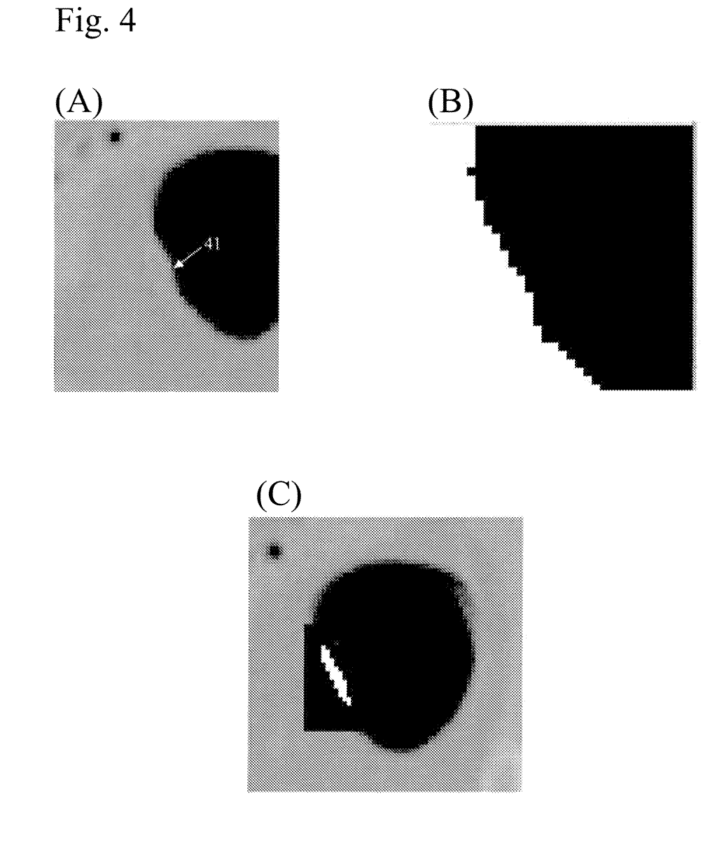

FIG. 4 is an illustration showing computer-assisted diagnosis (CAD) according to an exemplary embodiment of the present invention. Image (A) represents image data including a colonic polyp 41. Image (B) is a binarization of the colonic polyp 41 of Image (A). As can be seen from these images, the colonic polyp 41 is particularly flat in shape, and as such, detection of the polyp may be particularly difficult using conventional approaches. However, after applying an approach for morphological closing according to an exemplary embodiment of the present invention, closing of the flat colonic polyp 41 is successfully performed, as can be seen in Image (C), wherein the difference between the original image and the closed image is highlighted and identified as object 42.

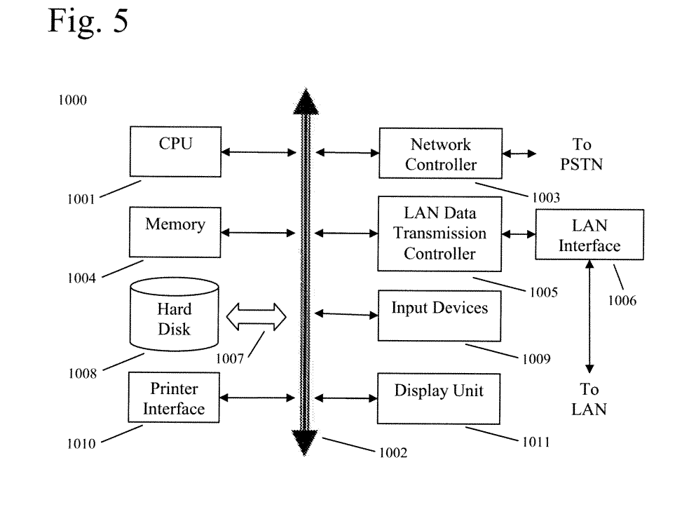

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for performing computer assisted diagnosis, comprising:
receiving medical image data of a structure under analysis including background and foreground pixels;
matching a set of one or more masks to foreground pixels of the acquired medical image data;
converting a background pixel of the acquired medical image data to foreground pixel based on a match between one of the masks and the acquired medical image data;
performing morphological dilation on the medical image data with the converted pixel;
performing morphological erosion on the dilated medical image data; and
identifying one or more regions of interest based on a difference between the original acquired medical image data and the eroded medical image data.

2. The method of claim 1, wherein prior to matching the set of one or more masks to the acquired medical image data, a background pixel of the acquired medical image data is converted to a foreground pixel based on domain knowledge pertaining to the structure under analysis.

3. The method of claim 1, wherein the medical image data is CT image data, MR image data, ultrasound image data, or PET image data.

4. The method of claim 1, wherein the set of one or more masks includes a master mask and one or more other masks that include a geometric pattern of the master mask that has been flipped or rotated.

5. The method of claim 4, wherein the geometric pattern of the master mask is selected to match the region of interest based on domain knowledge pertaining to the region of interest.

6. The method of claim 1, wherein the set of one or more masks includes an L-shaped pattern.

7. The method of claim 1, wherein the steps of matching the masks, converting the background pixel, performing the morphological dilation, and performing morphological erosion fill in one or more gaps within the acquired medical image.

8. The method of claim 7, wherein the steps of matching the masks, converting the background pixel, and performing the morphological dilation are repeated for a number of times “n” that is dependent upon the size of the one or more gaps that are filled.

9. The method of claim 8, wherein the step of performing morphological erosion on the dilated medical image data is repeated for a number of times “m” wherein m≧n.

10. The method of claim 9, wherein the repetition of matching the masks, converting the background pixels, performing morphpological dilation and performing morphological erosion remove one or more thin strips from the medical image data.

11. The method of claim 1, wherein the structure under analysis includes a colon and the one or more regions of interest represent colonic polyp candidates.

12. The method of claim 1, wherein the structure under analysis includes a lung and the one or more regions of interest represent pleura-attached nodule candidates.

13. The method of claim 1, wherein the structure under analysis includes a vessel or other tubular structure and the one or more regions of interest represent regions of intrusion into the vessel or other tubular structure.

14. A method for performing computer assisted diagnosis, comprising:
receiving medical image data of a structure under analysis including background and foreground pixels;
converting a background pixel of the acquired medical image data to foreground pixel based on domain knowledge pertaining to the structure under analysis;
performing morphological dilation on the medical image data with the converted pixel;
performing morphological erosion on the dilated medical image data; and
identifying one or more abnormality candidates based on a difference between the original acquired medical image data and the eroded medical image data.

15. The method of claim 14, wherein the medical image data is CT image data, MR image data, ultrasound image data, or PET image data.

16. The method of claim 14, wherein a set of one or more masks is used to convert the background pixel of the acquired medical image data to the foreground pixel by matching the masks to the acquired medical image data.

17. The method of claim 16, wherein the set of one or more masks includes a master mask and one or more other masks that include a geometric pattern of the master mask that has been flipped or rotated.

18. The method of claim 16, wherein the set of one or more masks includes an L-shaped pattern.

19. The method of claim 14, wherein the steps of converting the background pixel and performing the morphological dilation are repeated for a number of times “n” and the step of performing morphological erosion on the dilated medical image data is repeated for a number of times “m” wherein m≧n.

20. The method of claim 14, wherein the medical image data includes an image of a colon and the one or more regions of interest represent colonic polyp candidates.

21. The method of claim 14, wherein the medical image data includes an image of a lung and the one or more regions of interest represent pleura-attached nodule candidates.

22. A computer system comprising:
a processor; and
a program storage device readable by the computer system, embodying a program of instructions executable by the processor to perform method steps for performing computer assisted diagnosis, the method comprising:
receiving medical image data of a structure under analysis including background and foreground pixels;
matching a set of one or more masks to foreground pixels of the acquired medical image data;
converting a background pixel of the acquired medical image data to foreground pixel based on a match between one of the masks and the acquired medical image data;
performing morphological dilation on the medical image data with the converted pixel;
performing morphological erosion on the dilated medical image data; and
identifying one or more regions of interest based on a difference between the original acquired medical image data and the eroded medical image data.

23. The computer system of claim 22, wherein the steps of matching the masks, converting the background pixel, and performing the morphological dilation are repeated for a number of times “n” and the step of performing morphological erosion on the dilated medical image data is repeated for a number of times “m” wherein m≧n.
